(19) United States
(12) Patent Application Publication
(10) Pub. No.: US 2019/0342296 A1
(43) Pub. Date: Nov. 7, 2019

(54) AUTOMATED COMPLIANCE WITH SECURITY, AUDIT AND NETWORK CONFIGURATION POLICIES

(71) Applicant: MICROSOFT TECHNOLOGY LICENSING, LLC, Redmond, WA (US)

(72) Inventors: Parvez Anandam, Seattle, WA (US); Imran S. Koradia, Kirkland, WA (US); Zheng Tang, Bellevue, WA (US); Andrew Mendelsohn, Seattle, WA (US); Ankush Grover, Redmond, WA (US); Liyuan Zhou, Issaquah, WA (US); Brandon Michael Klassen, Clinton, WA (US); David A. Maltz, Bellevue, WA (US); Albert Gordon Greenberg, Seattle, WA (US)

(21) Appl. No.: 15/968,512

(22) Filed: May 1, 2018

(51) Int. Cl. H04L 29/06; H04L 12/24

(52) U.S. Cl. CPC H04L 63/101; H04L 41/0813; H04L 63/20

(57) ABSTRACT

Systems and methods are provided for facilitating automated compliance with security, audit and network configuration policies. In some instances, new runtime configuration files are iteratively generated and compared to a baseline configuration file to determine whether a threshold variance exists between the baseline configuration file and each separate and new runtime configuration file. If the threshold variance exists, remedial actions are triggered. In some instances, runtime configuration files are scanned for blacklist configuration settings. When blacklist configuration settings are found, remedial actions can also be triggered. In some instances, configuration files are scrubbed by omitting detected blacklist items from the configuration files. In some instances, changes are only made to configuration files when they match changes on an approved change list and are absent from an open incident list.

### CROSS-REFERENCE TO RELATED APPLICATIONS

This application is related to co-pending U.S. patent application Ser. No. 15/968,472, filed on May 1, 2018, entitled “AUTOMATED COMPLIANCE WITH SECURITY, AUDIT AND NETWORK CONFIGURATION POLICIES”.

### BACKGROUND

Computers and computing systems affect nearly every aspect of modern living. For instance, computers are generally involved in work, recreation, healthcare, transportation, entertainment, household management, etc.

The functionality of a computing system can be enhanced by its ability to be interconnected to other computing systems, such as by one or more network connections. Network connections may include, but are not limited to, connections via wired or wireless Ethernet, cellular connections, or even computer to computer connections through serial, parallel, USB, or other connections. Network connections allow a computing system to access services at other computing systems and to quickly and efficiently receive application data from other computing systems.

The interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

When a client utilizes distributed computing resources, such as provided through cloud services, they want to be assured that the computing resources will behave reliably, in predictable manner, with a desired quality of service. Unfortunately, computers and computer networks do not always behave as desired. For instance, computer performance can be degraded by hardware failures, software failures and/or malware.

Various standards bodies (e.g., NIST, FedRAMP, etc.) have been created to facilitate the manner in which the quality of service and reliability of a computing system can be measured. It is common, for example, for cloud services and other computer networks to undergo audits in which auditors assess compliance of a system's various components with established quality of service and reliability standards (e.g., NIST 800-171).

Software and hardware audits can, for example, provide some visibility into whether a computer system is likely to behave in a desired and predictable manner. One of the fundamental things that an auditor wants to know, when performing a system audit, is whether the runtime configurations of the system components match the known baseline configurations for those system components. If they do not match, the auditor will want to know why not (e.g., what changes were made to the configuration that caused a mismatch between the baseline configuration and the runtime configuration).

During an audit, an auditor will typically select random network events that have already processed and will review the archived records to show whether the event was processed properly by network components that are configured properly. These audits typically occur months after network events are processed, thereby limiting the benefit of the audit to a retrospective analysis. This can also make it difficult to identify the appropriate logs and records to determine the states and event states that were in existence at the randomly selected event time, to ensure compliance, particularly for large cloud systems.

When an auditor determines that there is a lack of compliance, the auditor can notify the system manager and may request additional information to understand why the device is not configured according to a standard or baseline configuration. Then, after determining whether any changes to the configuration(s) are warranted, the auditor can issue an assessed level of compliance that indicates whether the network system meets, or fails to meet, client demands. Unfortunately, this does not enable proactive mediation of existing problems that may exist for components that are currently in use and which may not be properly configured. The process of performing audits can also be very time consuming and, therefore, relatively expensive. For large networks, audits and compliance with various configuration policies is a difficult thing to implement and manage, particularly when these networks involve dynamic reconfigurations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed and claimed embodiments include systems and methods for facilitating automated compliance with security, audit and network configuration policies.

In some embodiments, methods and systems are provided for validating requested changes, in real-time, based on an authorized change list. In such embodiments, requested configuration changes are monitored for and detected for network devices. These network devices have stored runtime configuration files that match stored baseline configuration files. When a requested configuration changes is detected, an authorized change list is accessed and used to determine whether the requested change matches a change that is identified within a plurality of authorized changes included in the authorized change list. Thereafter, upon determining the requested change is identified by or included in the authorized change list, the requested change is authorized to be made to the device (e.g., changing the device runtime configuration). Otherwise, if the requested change is not identified by or included in the authorized change list, the requested change is not authorized and the requested change not being made to the device. When the requested change is not identified in the authorized change list, this can also trigger a remedial action.

As will be appreciated, from this disclosure, the referenced systems and methods can be used to facilitate automated compliance with security, audit and network configuration policies in a way that was not previously possible. These systems and methods can be particularly helpful to overcome many of the technical difficulties associated with existing techniques for performing audits of network configurations and can, therefore, further help to improve the timing and manner in which remedial actions can be taken in response to dynamic and detected non-compliant configurations and reconfiguration requests.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a flow diagram that includes various acts associated with disclosed methods for facilitating automated compliance with configuration policies within a network that includes a plurality of network devices;

FIG. 2 illustrates another flow diagram that includes various acts associated with disclosed methods for facilitating automated compliance with configuration policies within a network that includes a plurality of network devices;

FIG. 3 illustrates another flow diagram that includes various acts associated with disclosed methods for facilitating automated compliance with configuration policies within a network that includes a plurality of network devices;

FIG. 4 illustrates another flow diagram that includes various acts associated with disclosed methods for facilitating automated compliance with configuration policies within a network that includes a plurality of network devices;

FIG. 5 illustrates a diagram of a system and computing environment that can be used for facilitating automated compliance with configuration policies within a network that includes a plurality of network devices;

FIG. 6 illustrates an example of runtime configuration files and a baseline configuration file;

FIG. 7 illustrates an example of runtime configuration files and a scrubber file;

FIG. 8 illustrates an example of runtime configuration files and a blacklist file, along with a listing of remedial actions;

FIG. 9 illustrates an examples of change requests and a policy/rules index, along with an incident management index; and

FIG. 10 illustrates an example, like in FIG. 5, of a system and computing environment that can be used for facilitating automated compliance with configuration policies within a network that includes a plurality of network devices.

### DETAILED DESCRIPTION

Disclosed and claimed embodiments include systems and methods for facilitating automated compliance with security, audit and network configuration policies.

In some instances, the disclosed embodiments can be used to help overcome some of the technical difficulties associated with existing techniques for performing audits of network configurations. For instance, many of the disclosed embodiments can be used to facilitate real-time remedial actions that are triggered during the auditing of device configurations and for ensuring network device configurations are maintained in compliance with desired configuration standards. Disclosed embodiments can also help to facilitate the manner in which compliance is validated and the manner in which validation records are accessed and stored.

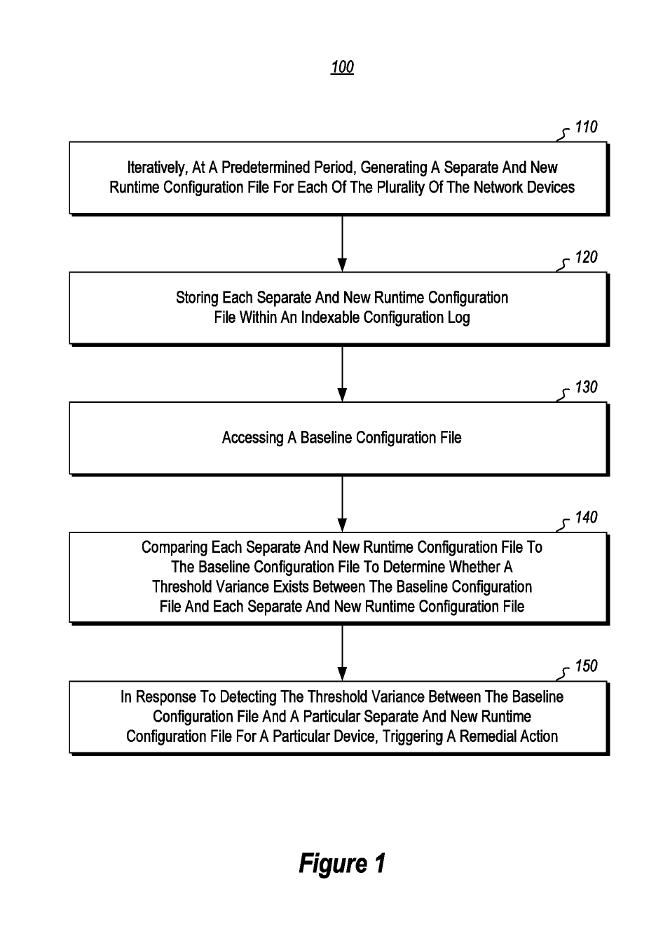

The following discussion will refer to a number of methods and method acts that may be performed. For instance, FIGS. 1-4 illustrate various flow diagrams that include acts and methods associated with the disclosed embodiments for facilitating automated compliance with security, audit and network configuration policies. Although the method acts may be discussed in a certain order or illustrated in a flow chart as occurring in a particular order, no particular ordering is required unless specifically stated, or required because an act is dependent on another act being completed prior to the act being performed.

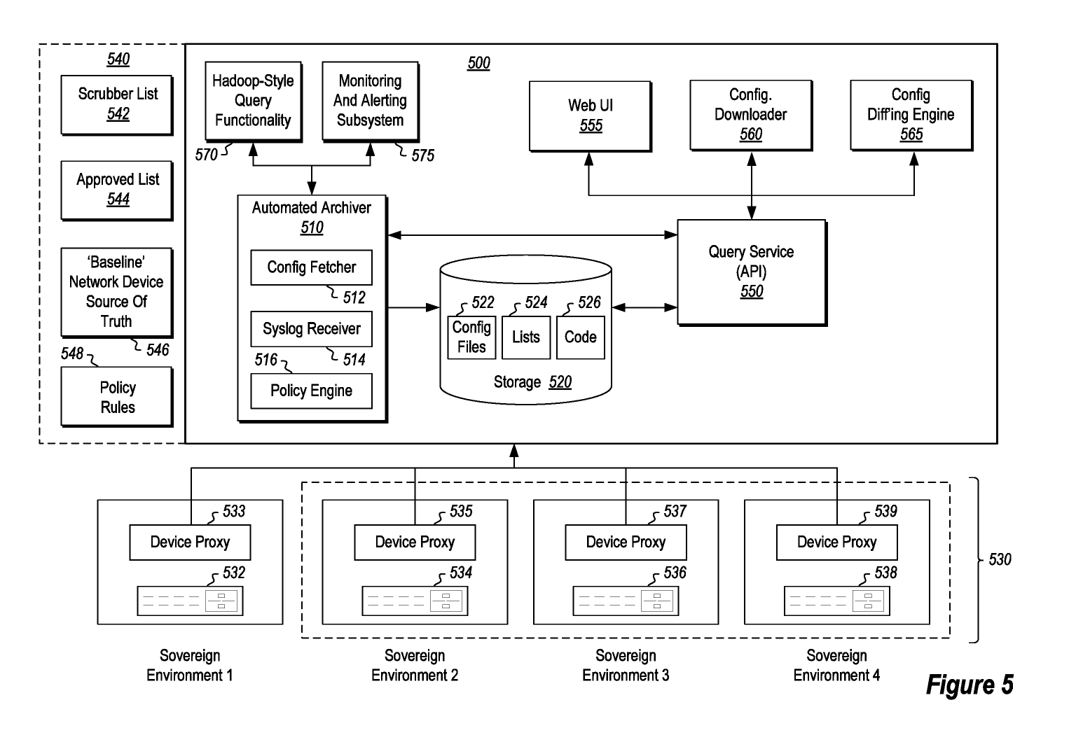

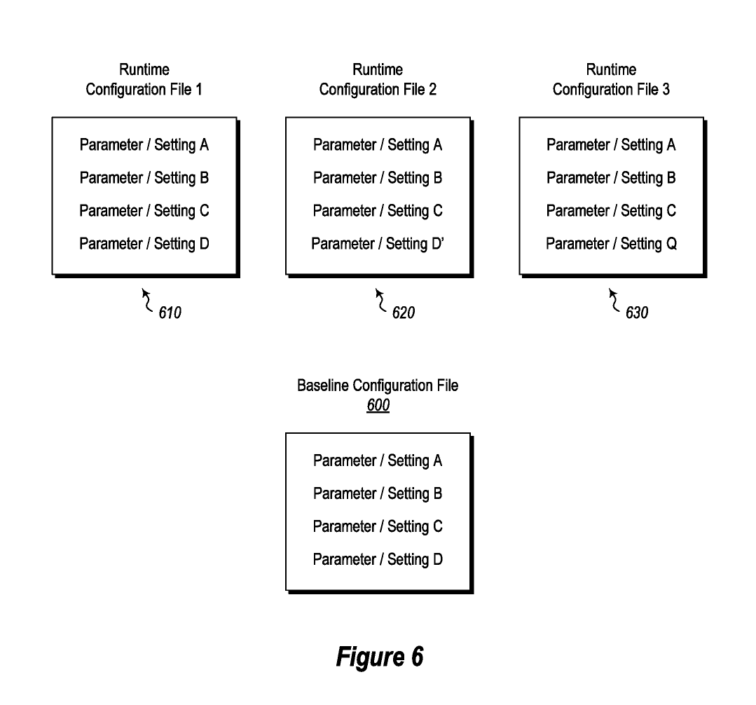

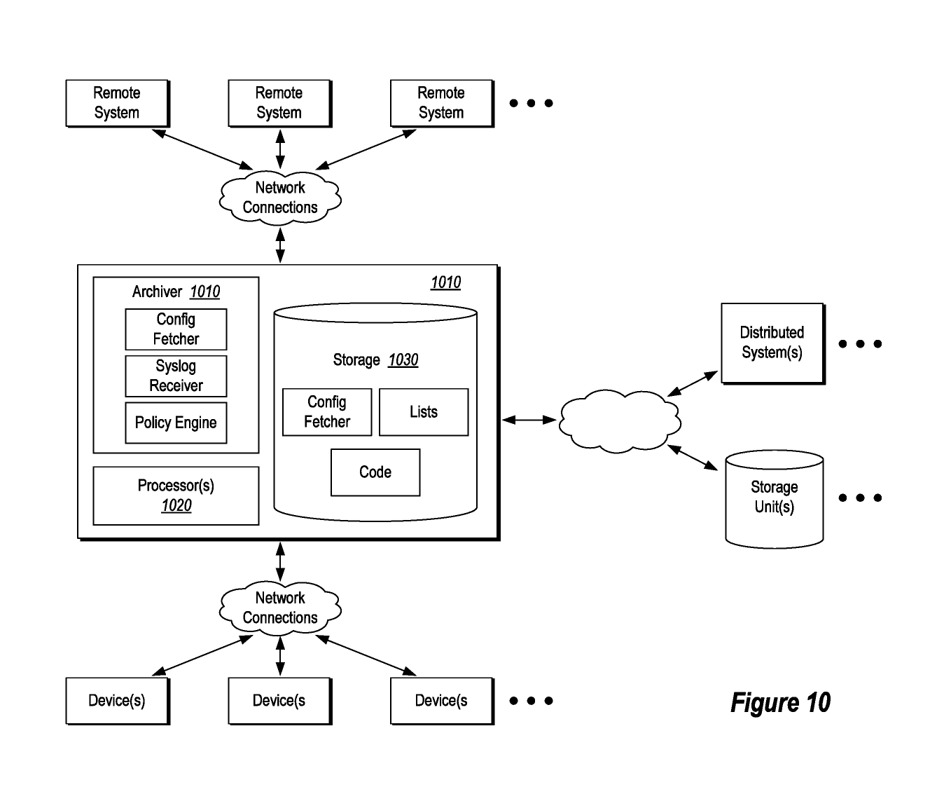

While describing the methods referenced in FIGS. 1-4, reference will be made to the systems illustrated in FIGS. 5 and 10, which are capable of implementing the disclosed methods. Reference will also be made to FIGS. 6-9, which illustrate exemplary structures of for use in implementing the disclosed embodiments.

Attention is first directed to FIG. 1, which illustrates a method 100 for performing automated compliance with configuration policies within a network that includes a plurality of network devices. This method 100 includes various acts, including acts for obtaining separate and new runtime configuration files for each of the plurality of the network devices in a network, on an iterative and periodic basis (act 110). The iterative and periodic basis may comprise a daily basis, a weekly basis, an hourly basis, a monthly basis, or a periodic basis that is based on or reset in response to the occurrence of a particular event (e.g., the request for a change to be made to the configuration file).

Each runtime configuration file that is obtained can be copies, for example, of the runtime configuration files that are currently being used by the corresponding network devices. In some instances, the different runtime configuration files that are obtained are archived and indexed (act 120) within a configuration log that tracks different configurations for correspondingly different devices. In some instances, a different log is created for each device. In other instances, a configuration file log is created and shared among a plurality of different devices based on device type or device location.

The archived copies of the configuration files can be accessed through the index/logs to facilitate subsequent auditing and review of the configuration files. In some instances, the configuration logs identify, with each variation of a configuration file, a change request/event that resulted in making a change to the configuration file.

A baseline configuration file is also accessed (act 130), which is compared to each separate and new runtime configuration file that was obtained/archived (act 140). The baseline configuration file represents the source of truth and may be stored in a separate database or domain than the archived runtime configuration files.

The comparison between the baseline configuration file and the various runtime configuration files can occur prior to or subsequent to the archiving of the runtime configuration files. The comparison is performed to determine whether a threshold variance exists between the baseline configuration file and each separate and new runtime configuration file. This threshold variance can be a predetermined variance, such as a certain percentage of deviation between the baseline configuration file and the runtime configuration file (e.g., 1%, 5%, 10% or another percentage). Alternatively, the threshold variance can be a variance of a particular predefined key or name/value pairing included in the baseline configuration file (e.g., a name/value pair associated with permissions, communication protocols, etc.). The threshold variance can also comprise a predetermined quantity of changed lines or name/value pairs in the configuration file. The threshold variance can also be a temporal reference to a predetermined passage of time from the time in which the runtime configuration file was created and/or verified to match the baseline configuration file. The threshold variance can also be any combination of the foregoing.

When the threshold variance is detected between the baseline configuration file and a particular runtime configuration file for a particular computing device, a remedial action is triggered (act 150).

The triggering of the remedial action occurs automatically, without requiring user input in some instances. In other instances, the remedial action is queued up for execution in response to detecting the threshold variance, but is only implemented in response to an execute command being received.

In some instances, the remedial action comprises generating a notification that identifies at least one of the particular computing device or the runtime configuration file for the particular computing device, as well as at least one change event that caused the threshold variance. This notification can also include, additionally or alternatively, another remedial action that is queued up for execution and that is displayed with an execute command that is selectable to (when selected) trigger execution of the other remedial action.

In some instances, the remedial action includes isolating the particular computing device from a network associated with the particular computing device and so that the particular computing device is no longer used to process network packets on the network and by at least re-routing traffic on the network away from the particular computing device to a different computing device.

In some instances, the remedial action includes performing a partial reversion of the particular computing device by reconfiguring portions of a runtime configuration file being used by the particular computing device that are different than the baseline configuration file, so that they will be the same, and then subsequently validating that the runtime configuration file being used by the particular computing device is the same as the baseline configuration file (such as through a subsequent comparison process).

In some instances, the remedial action includes performing a complete reversion of the particular computing device by replacing or overwriting a runtime configuration file that is being used by the particular computing device with a copy of the baseline configuration file.

In some instances, the remedial action includes modifying a functionality of the particular computing device by applying a new restriction on use of the particular computing device, such as by limiting access to the particular computing device to use during particular processes or users, times of the day, permissions or authorizations required for use, etc.

Examples of runtime configuration files (610, 620 and 630) are illustrated in FIG. 6, as is an example baseline configuration file 600. While implementing method 100, a comparison of a first runtime configuration file (610), associated with a first device or a first instance/copy, might reveal that there is no difference between runtime configuration file 610 and baseline configuration file 600 that satisfies the threshold variance. However, a comparison of another configuration file (630) might reveal a difference between parameter/setting Q of configuration file (630) and parameter/setting D of baseline configuration file 600, which is sufficient to trigger a remedial action. The parameter/setting may be a key or name/value pair, for example.

The difference between the parameter/setting D′ of configuration file 620 and the parameter/setting D of configuration file 600 may be sufficient to trigger an automatic remedial action in some instances, but not in others. In some embodiments, certain threshold variances will trigger a first set of remedial actions and different threshold variances will trigger different remedial actions, such that the type of remedial action that is triggered will be based on how severe and/or what type of variations there are between the baseline configuration file and the runtime configuration files. For instance, by way of example, a detected change or variation in the runtime configuration file associated with a write parameter for the device, relative to the baseline configuration, will trigger a different remedial action than a change/variation in the configuration file associated with a write parameter for the device.

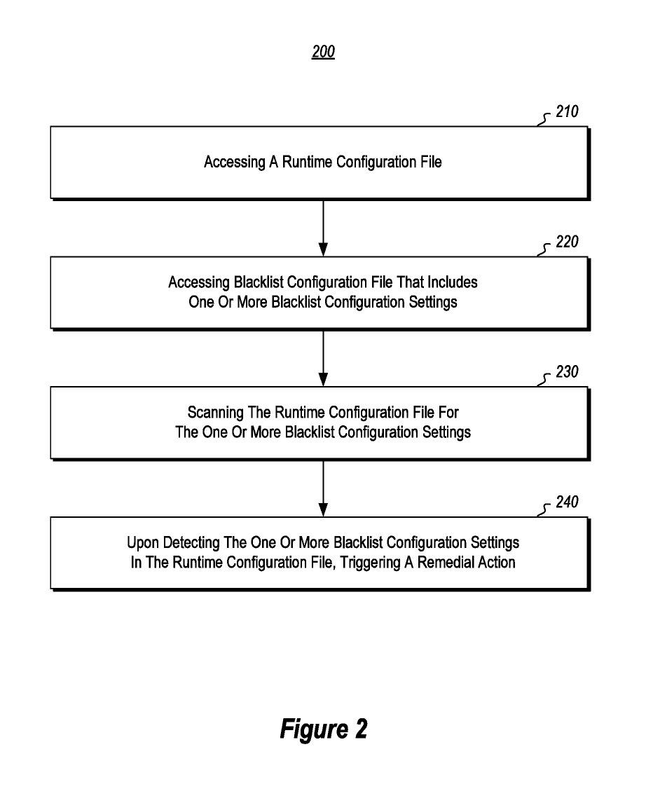

Attention is now directed to FIG. 2, which illustrates another method 200 for performing automated compliance with configuration policies within a network that includes a plurality of network devices. As shown, this method includes accessing a runtime configuration file for a particular computing device (act 210). This may include, for example, accessing a copy of an archived runtime configuration file (such as described above). Alternatively, this may include accessing a runtime configuration file that is currently being used by a device.

This method also includes accessing a blacklist configuration file that includes one or more blacklist configuration settings (act 220) and scanning the runtime configuration file for the one or more blacklist configuration settings (act 230). These blacklist configuration settings may be any setting that is determined to be undesirable for a particular network component. Upon detecting the one or more blacklist configuration settings in the runtime configuration file, a remedial action is triggered (act 240). By way of example, in some instances a network administrator may want to include blacklist configuration settings to the blacklist, such as a ‘telnet’ configuration or an unencrypted enabled configuration that will trigger a remedial action, when discovered. The remedial action that is triggered may be the same as the previously disclosed remedial actions and may be triggered automatically.

In some instances, the remedial action comprises generating a notification that identifies at least one of the particular computing device or the runtime configuration file for the particular computing device, as well as at least one change event that created the blacklist configuration settings.

In some instances, the remedial action comprises isolating the particular computing device from a network and so that the particular computing device is no longer used to process network packets and by at least re-routing traffic away from the particular computing device to a different computing device.

In some instances, the remedial action includes performing a partial reversion of the particular computing device by reconfiguring portions of the runtime configuration file that contain the blacklist configuration settings and thereafter validating that the runtime configuration file being used by the particular computing device no longer has any blacklist configuration settings.

In some instances, the remedial action comprises performing a complete reversion of the particular computing device by replacing or overwriting the runtime configuration file that is being used by the particular computing device with a copy of the baseline configuration file.

In some instances, the remedial action includes modifying a functionality of the particular computing device by applying a new restriction on use of the particular computing device.

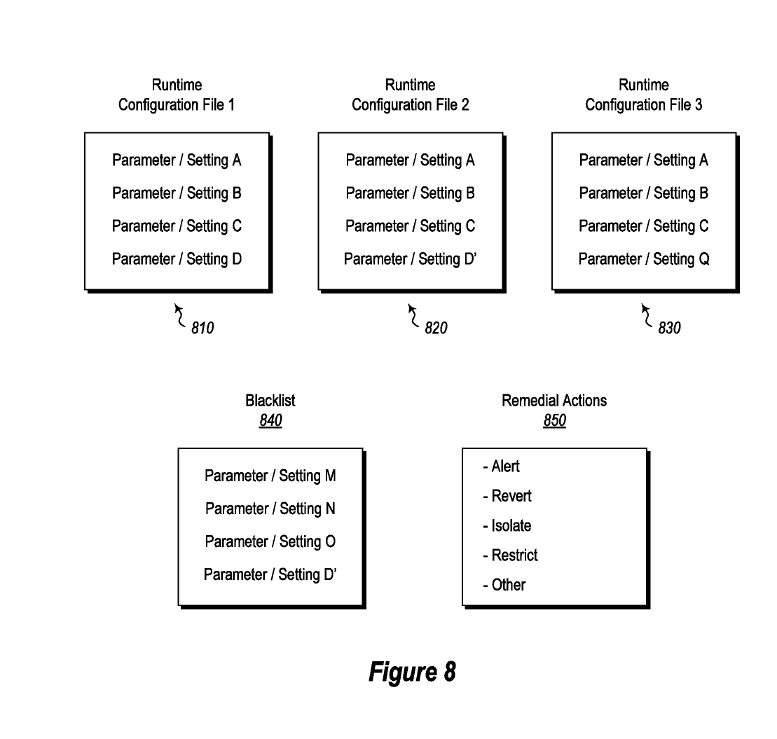

FIG. 8 illustrates a plurality of runtime configuration files 810, 820 and 830, as well as a blacklist 840 and a remedial actions data structure 850.

During implementation of the method 200 illustrated in FIG. 2, the system may compare, for example, the runtime configuration files 810, 820 and 830 to look for any elements that match one or more elements included in the blacklist configuration file 840. In this instance, configuration file 830 does not have any matching elements to the blacklist 840, while configuration file 820 does (e.g., parameter/setting D′).

Configuration file 810 has an element (i.e., parameter/setting D) that is similar to an element in the blacklist (i.e., parameter/setting D′), but not the same. In some instances, a presence of an element that is similar, but not identical will not trigger a remedial action. In other instances, the presence of a particular element in a runtime configuration file that is similar to an element in the blacklist, but not identical, (e.g., a derivative or variant of the blacklist element or an element that causes the same functionality as a blacklist element) will still be sufficient to automatically trigger a remedial action.

When a remedial action is triggered, code for executing the remedial action can be obtained from a stored data structure, such as remedial actions data structure 850, which may be stored by the system that performs the comparing of the configuration files or by another system.

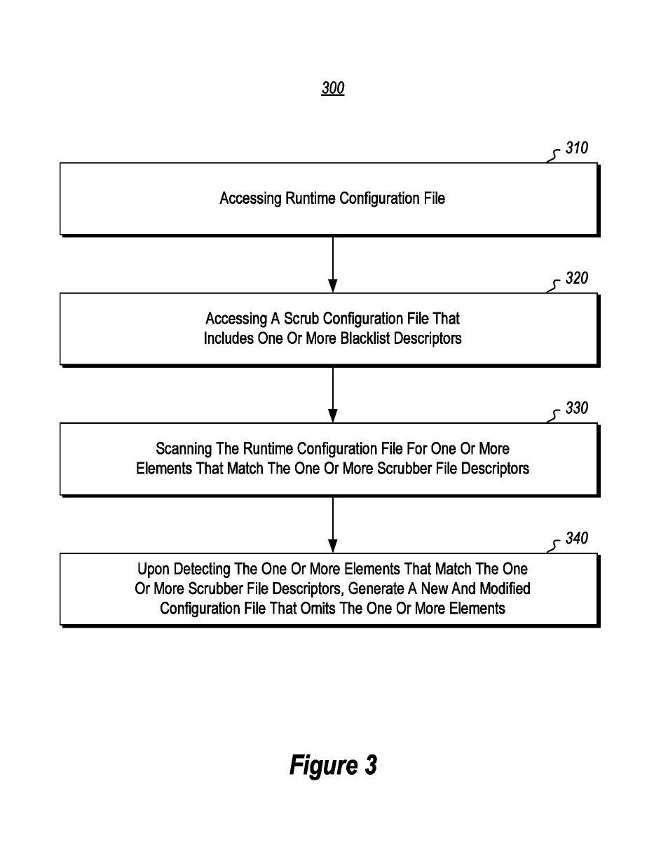

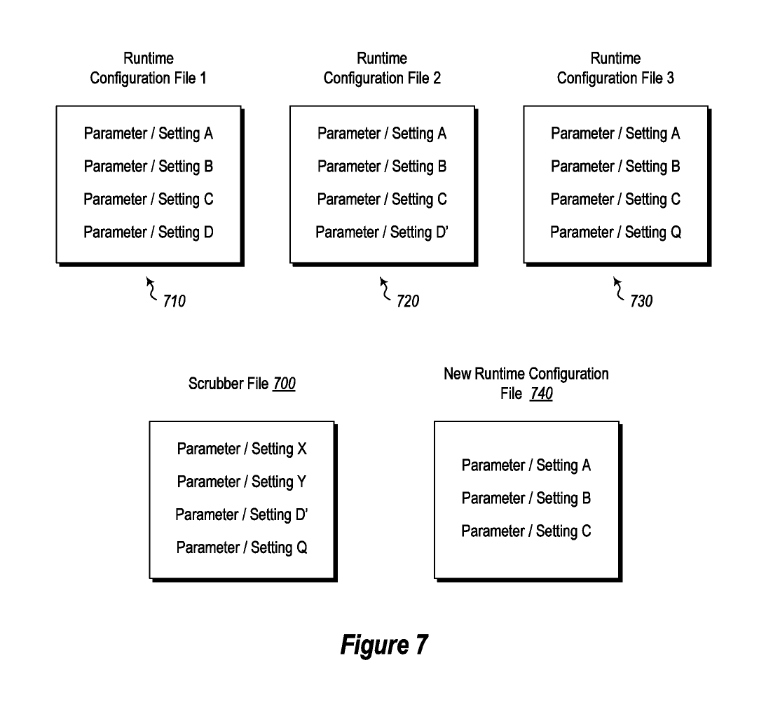

Attention is now directed to FIGS. 3 and 7. In this embodiment, a computing system implements a method (300) for performing automated compliance with configuration policies within a network by utilizing a scrubber file.

First, a runtime configuration file is accessed for a particular computing device (act 310). This may be an archived copy of a runtime configuration file or a configuration file that is currently in use.

A scrub configuration file (e.g., scrubber file 700) is also accessed (act 320). This scrubber file 700 includes one or more blacklist descriptors that identify elements that are sensitive and should be eliminated from the runtime configuration files, particularly before being archived or transmitted. For example, an enterprise may not want to transmit certain sensitive information outside of their enterprise (e.g., name/value pairs that identify sensitive proprietary process names). In some instances, the blacklist descriptors identify sensitive data that cannot or should not be transmitted out of a country due to country regulations (e.g., personal information associated with privacy requirements).

As illustrated, the runtime configuration file is scanned for one or more elements that match the one or more blacklist descriptors (act 330) and then, upon detecting the one or more elements that match the one or more blacklist descriptors, generating at least one of a new or modified runtime configuration file that omits the one or more elements and that is used by the particular computing device during runtime (act 340).

In some instances, the offending runtime configuration is modified by omitting the offending blacklist descriptor from the runtime configuration file before it is archived, after it is archived, and/or before it is transmitted to a remote system. In other instances, the runtime configuration file is replaced with a new runtime configuration copy that omits the blacklist descriptors before it is archived, after it is archived, and/or before it is transmitted to a remote system.

In some instances, the new or modified runtime configuration file is subsequently compared to a baseline configuration file to determine whether a threshold variance exists between the baseline configuration file and the new or modified runtime configuration file.

Then, in response to detecting the threshold variance exists between the baseline configuration file and the new or modified runtime configuration file, a remedial action is triggered. Including any of the foregoing remedial actions described herein.

In some instances, the remedial action comprises generating a notification that identifies at least one of the particular computing device or the new or modified runtime configuration file.

In some instances, the remedial action comprises isolating the particular computing device from a network associated with the particular computing device and so that the particular computing device is no longer used to process network packets on the network and by at least re-routing traffic on the network away from the particular computing device to a different computing device.

In some instances, the remedial action comprises performing a partial or complete reversion of the particular computing device by reconfiguring portions of the new or modified runtime configuration file so that it matches the baseline configuration file. The remedial action may also include modifying a functionality of the particular computing device by applying a new restriction on use of the particular computing device, as previously described.

FIG. 7 illustrates various configuration files 710, 720 and 730, along with a scrubber file 700. In this embodiment, runtime configuration files 710 and 720 do not have any blacklist elements (e.g., elements identified in the scrubber file 700). However, runtime configuration file 730 does (i.e., parameter/setting Q). Accordingly, the disclosed embodiment includes modifying this configuration file 730 and/or creating a new configuration file, such as new runtime configuration file 740, that omits the one or more identified blacklist elements prior to archiving, subsequent to archiving and/or prior to transmitting the runtime confirmation file for that particular instance/device.

In some embodiments, this may include (in response to a request for the runtime configuration file 730) keeping an archived copy of runtime configuration file 730, but only transmitting the new runtime configuration file 740, even though the runtime configuration file 730 was requested.

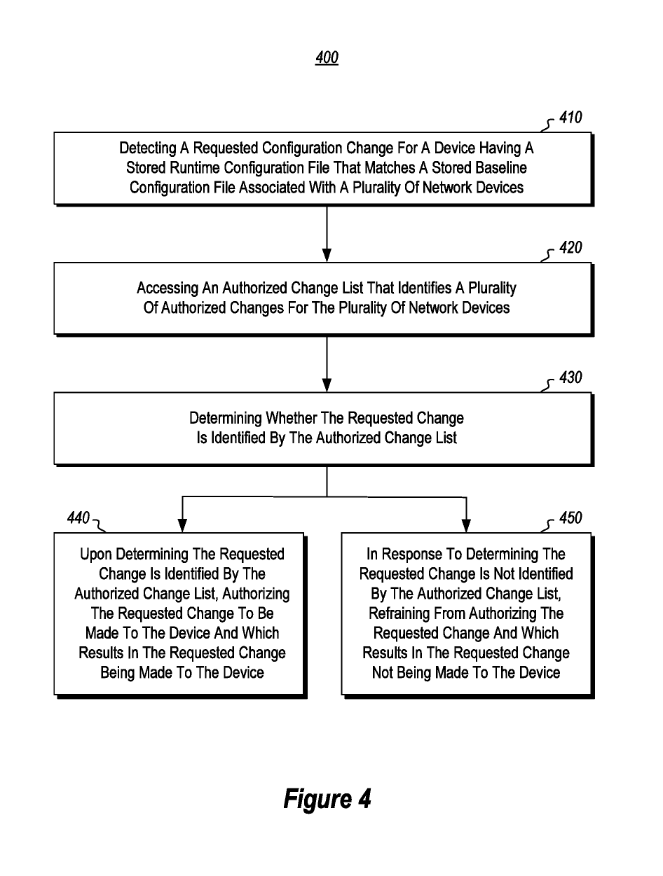

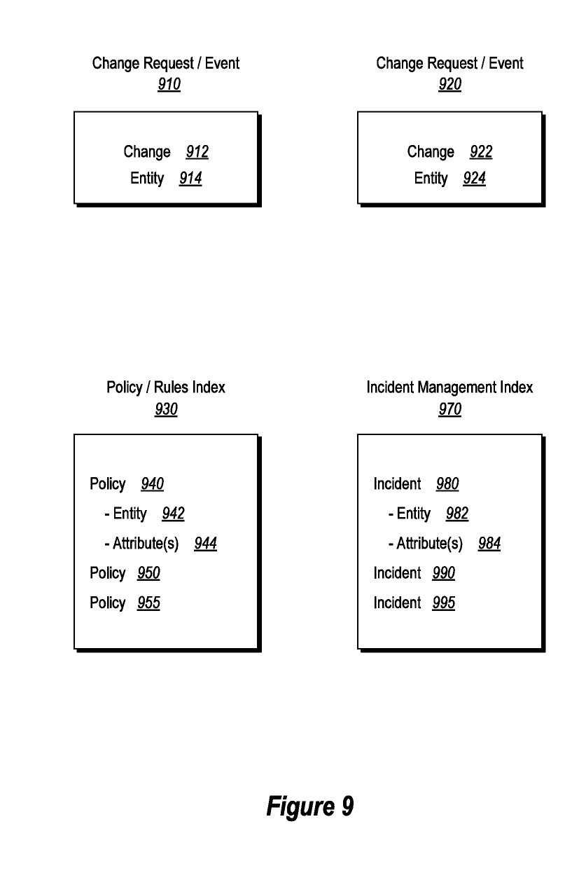

Attention is now directed to FIGS. 4 and 9, which illustrate embodiments for managing system configuration changes. As illustrated, the method 400 of FIG. 4 includes detecting a requested configuration change for a particular computing device having a stored runtime configuration file that matches a stored baseline configuration file associated with a plurality of network devices (act 410). Then, in response to this requested configuration change (e.g., a change request), the system accesses an authorized change list that identifies a plurality of authorized changes for the plurality of network devices (act 420). Thereafter, it is determined whether the requested change is identified by the authorized change list (act 430). If the requested change is identified by the authorized change list, then the requested change is authorized to be made to the device and which results in the requested change being made to the runtime configuration file. This may result in creating a new replacement configuration file and/or a modified runtime configuration file (act 440). Alternatively, in response to determining the requested change is not identified by the authorized change list, the system refrains from authorizing the requested change and which results in the requested change not being made to the runtime configuration file (act 450).

In some instances, the identification of the requested change on the authorized change list includes determining that the requested change is made by an authorized entity and/or that the change is an authorized changed.

FIG. 9 illustrates two change requests 910 and 920, that include corresponding change attributes (912, 922) and entity attributes (914, 924). FIG. 9 also illustrates an authorized change list in the form of a policy/rules index 930. When the change requests 910 and 920 are received, it is determined whether the change and/or entity attributes (912, 914, 922, 924) match the authorized policies in the policy/rules index 930, which specify the corresponding entity 942 and other attributes 944 that correspond to or match authorized changes to be made. Then, if they match, the change is authorized and can be made. Otherwise, if they don't match, the change is not authorized and the system refrains from making/authorizing the change.

In some instances, a change that is not authorized/identified in the authorized change list (e.g., policy/rules index) can still be made if it is determined that the change request comprises attributes/elements that match a separately maintained incident management index 970. The incident management index 970 stores incidents that have been opened for different network devices, including attributes for the incident, such as the entities involved/authorized to be involved and other attributes, such as authorized scope of changes to be made or that have been made.

For instance, if change 922, requested by entity 924 does not match the policies in the policy rules index 930 (e.g., does not match policy 940, 950 or 955), the system will determine whether there is a match within an incident management index 970 (e.g., whether there is a match with incident 980, 990 or 995). In this case, a determination is made that entity 924 is the same as 982 and the change 922 matches the scope of changes involved in an open ticket, as specified by attribute(s) 984. Accordingly, in this instance, the change 922 is authorized, and is performed to the runtime configuration file, even though the change request 920 did not match any allowed changes specified by policy/rules index 930. This provides enhanced flexibility for real-time selective authorized changes due to management of open incidents, while still permitting an enterprise to manage/enforce overall policies in a more general way.

In some instances, after modifying the runtime configuration file and/or generating a new modified runtime configuration file, it is compared to the baseline configuration file to determine whether a threshold variance exists between the baseline configuration file and the new or modified runtime configuration file. Thereafter, in response to detecting the threshold variance exists between the baseline configuration file and the modified runtime configuration file, a remedial action is triggered, such as the aforementioned remedial actions.

In some instances, the remedial action comprises isolating the particular computing device from a network associated with the particular computing device and so that the particular computing device is no longer used to process network packets on the network and by at least re-routing traffic on the network away from the particular computing device to a different computing device.

In some instances, the remedial action comprises performing a partial or complete reversion of the particular computing device by reconfiguring portions of the modified runtime configuration file so that it matches the baseline configuration file.

In some instances, the remedial action comprises modifying a functionality of the particular computing device by applying a new restriction on use of the particular computing device.

In some instances, a record is also created that references a copy of the requested configuration change along with a copy of the modified runtime configuration file. This record can be transmitted as part of the remedial actions in a notification that is generated. This record can also be easily accessed at a later time through audit interfaces to facilitate the auditing process.

Attention is now directed to FIGS. 5 and 10, which illustrate computing systems that can be utilized to implement and/or that include aspects of the claimed and disclosed embodiments.

As shown in FIG. 5, a system 500 that is in communication with a network 530 that includes a plurality of network devices (e.g., 532, 534, 536, 538). Each of these devices can include its own device proxy (e.g., 533, 535, 537, 539) or they may share proxies (not shown). The proxies communicate with the system 500 to provide the runtime configuration files and/or information that is used to build the runtime configuration files described herein. The devices operate according to the hardware and software they are configured with, which software includes the runtime configuration files. Sometimes, an entity may attempt to change a configuration file, and to thereby alter the device functionality. The disclosed embodiments help to manage this type of behavior, to limit changes to authorized changes. The disclosed embodiments also help to ensure that the managed configuration files are managed in such a manner that sensitive data is not inadvertently disclosed from the configuration files, even during auditing.

In some instances, the system 500 accesses and utilizes various data structures 540, such as the previously described scrubber files (e.g., scrubber list 542), approved list 544 (e.g., policy/rules index 930, incident management index 970 and even blacklist 840—which is actually a disapproved list), baseline configuration file (e.g., baseline network device source of truth 546) and policy rules 548 (e.g., other types of policies, such as remedial actions 850).

These various data structures 540 can be stored remotely from the system 500 or maintained in local and/or distributed storage 520 of the system. Accordingly, as reflected by element 524, the storage 520 may store any combination of the various lists 524 described herein (which may include any or all of the disclosed data structures). The storage 520 may also store the configuration files 522 disclosed herein (e.g., baseline configuration files, archived runtime configuration files and new/modified configuration files). The storage 520 also stores code for performing the disclosed functionality and methods, in response to being executed by hardware processors of the system (not shown here, but shown in FIG. 10). By way of example, the code 526 may include code for comparing configuration files and triggering and executing the remedial actions, as disclosed.

In some instances, the code 526 is utilized by the automated archiver 510 for obtaining, archiving, copying, transmitting and/or modifying configuration files with the config fetcher 512. The config fetcher 512, for example, interfaces with the device proxies to obtain the configuration files that are archived.

The syslog receiver 514 is utilized by the automated archiver 510 to obtain and analyze the various change requests that are received. The policy engine 516 references the various policies and lists when the automated archiver 510 analyzes the configuration files to determine when configuration files should be scrubbed, modified, copied, archived, transmitted and/or when to trigger remedial actions based on the specified policies and corresponding data structures, as described herein.

The Query Service (API) 550 is used to interface with the storage 520, to identify and access configuration files and to obtain the differencing information from a Config Diff'ing Engine 565 to modify stored configuration files that need to be modified in storage 520 in the manner that has been described and/or to modify runtime configuration files via device proxies. Likewise, the Query Service (API) provides interfaces for Config Downloader 560 to download baseline configuration files used during full file reversion and to interface with the device proxies to complete the reversion process. The Query Service (API) 550 also utilizes Web UI 555 to present interfaces to auditors and administrators to access the various lists 524 and configuration files 522.

In some instances, a Hadoop-Style Query Functionality module is also provided to facilitate Boolean searching for different configuration policies stored in storage 520 or the various data structures 540.

Finally, the disclosed system utilizes a monitoring and alerting subsystem 575 to perform the triggered remedial actions, including the generation of alerts and notifications to administrators of unauthorized change requests and/or of configuration files that are not aligned with current policies and baseline configurations.

It will be appreciated that this computing environment is only one example of a computing environment that may be utilized to implement the disclosed embodiments.

Other embodiments are represented by the computing system shown in FIG. 10, wherein a computing system 1010 includes an archiver 1010, analogous to automated archiver 510, and storage 1030, analogous to storage 520. In this environment, one or more processors 1020 are used to execute stored code to interface with remote systems and network devices through network connections to implement the disclosed embodiments. In some instance, the system 1010 is also connected to or includes other distributed systems and storage units that perform distributed portions of the functionality described herein.

Accordingly, it will be appreciated that the disclosed methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more hardware storage device storing computer-executable instructions that are executable, when executed by the one or more processors, for causing the computing system to implement a method for managing system configuration changes, the method comprising:
detecting a requested configuration change for a particular computing device having a stored runtime configuration file that matches a stored baseline configuration file associated with a plurality of network devices;
accessing an authorized change list that identifies a plurality of authorized changes for the plurality of network devices;
determining whether the requested change is identified by the authorized change list; and
upon determining the requested change is identified by the authorized change list, authorizing the requested change to be made to the device and which results in the requested change being made to the runtime configuration file and which includes creating a modified runtime configuration file, or alternatively, in response to determining the requested change is not identified by the authorized change list, refraining from authorizing the requested change and which results in the requested change not being made to the runtime configuration file.

2. The computing system recited in claim 1, wherein the method further includes comparing the modified runtime configuration file to the baseline configuration file to determine whether a threshold variance exists between the baseline configuration file and the new or modified runtime configuration file.

3. The computing system recited in claim 2, wherein the method further includes, in response to detecting the threshold variance exists between the baseline configuration file and the modified runtime configuration file, triggering a remedial action.

4. The computing system recited in claim 3, wherein the method further includes creating a record that references a copy of the requested configuration change along with a copy of the modified runtime configuration file and wherein the remedial action comprises generating a notification that includes the record.

5. The computing system recited in claim 3, wherein the remedial action comprises isolating the particular computing device from a network associated with the particular computing device and so that the particular computing device is no longer used to process network packets on the network and by at least re-routing traffic on the network away from the particular computing device to a different computing device.

6. The computing system recited in claim 3, wherein the remedial action comprises:
performing a partial reversion of the particular computing device by reconfiguring portions of the modified runtime configuration file so that it matches the baseline configuration file.

7. The computing system recited in claim 3, wherein the remedial action comprises:
modifying a functionality of the particular computing device by applying a new restriction on use of the particular computing device.

8. A computer-implemented method for managing system configuration changes, the method comprising:
detecting a requested configuration change for a particular computing device having a stored runtime configuration file that matches a stored baseline configuration file associated with a plurality of network devices;
accessing an authorized change list that identifies a plurality of authorized changes for the plurality of network devices;
determining whether the requested change is identified by the authorized change list; and
upon determining the requested change is identified by the authorized change list, authorizing the requested change to be made to the device and which results in the requested change being made to the runtime configuration file and which includes creating a modified runtime configuration file, or alternatively, in response to determining the requested change is not identified by the authorized change list, refraining from authorizing the requested change and which results in the requested change not being made to the runtime configuration file.

9. The method recited in claim 8, wherein the method further includes comparing the modified runtime configuration file to the baseline configuration file to determine whether a threshold variance exists between the baseline configuration file and the new or modified runtime configuration file.

10. The method recited in claim 9, wherein the method further includes, in response to detecting the threshold variance exists between the baseline configuration file and the modified runtime configuration file, triggering a remedial action.

11. The method recited in claim 10, wherein the method further includes creating a record that references a copy of the requested configuration change along with a copy of the modified runtime configuration file and wherein the remedial action comprises generating a notification that includes the record.

12. The method recited in claim 10, wherein the remedial action comprises isolating the particular computing device from a network associated with the particular computing device and so that the particular computing device is no longer used to process network packets on the network and by at least re-routing traffic on the network away from the particular computing device to a different computing device.

13. The method recited in claim 10, wherein the remedial action comprises:
performing a partial reversion of the particular computing device by reconfiguring portions of the modified runtime configuration file so that it matches the baseline configuration file.

14. The method recited in claim 10, wherein the remedial action comprises:
modifying a functionality of the particular computing device by applying a new restriction on use of the particular computing device.

15. A computer program product comprising one or more hardware storage devices having stored computer-executable instructions that are executable, when executed by one or more processors of a computing system, for causing the computing system to implement a method for managing system configuration changes, the method comprising:
detecting a requested configuration change for a particular computing device having a stored runtime configuration file that matches a stored baseline configuration file associated with a plurality of network devices;
accessing an authorized change list that identifies a plurality of authorized changes for the plurality of network devices;
determining whether the requested change is identified by the authorized change list; and
upon determining the requested change is identified by the authorized change list, authorizing the requested change to be made to the device and which results in the requested change being made to the runtime configuration file and which includes creating a modified runtime configuration file, or alternatively, in response to determining the requested change is not identified by the authorized change list, refraining from authorizing the requested change and which results in the requested change not being made to the runtime configuration file.

16. The computer program product recited in claim 15, wherein the method further includes comparing the modified runtime configuration file to the baseline configuration file to determine whether a threshold variance exists between the baseline configuration file and the new or modified runtime configuration file.

17. The computer program product recited in claim 16, wherein the method further includes, in response to detecting the threshold variance exists between the baseline configuration file and the modified runtime configuration file, triggering a remedial action.

18. The computer program product recited in claim 17, wherein the method further includes creating a record that references a copy of the requested configuration change along with a copy of the modified runtime configuration file and wherein the remedial action comprises generating a notification that includes the record.

19. The computer program product recited in claim 17, wherein the remedial action comprises isolating the particular computing device from a network associated with the particular computing device and so that the particular computing device is no longer used to process network packets on the network and by at least re-routing traffic on the network away from the particular computing device to a different computing device.

20. The computer program product recited in claim 17, wherein the remedial action comprises:
performing a partial reversion of the particular computing device by reconfiguring portions of the modified runtime configuration file so that it matches the baseline configuration file.
